(19) United States
(12) Patent Application Publication
(10) Pub. No.: US 2025/0073838 A1
(43) Pub. Date: Mar. 6, 2025

(54) POWER TOOL INCLUDING TOUCH-BASED CONTROL

(71) Applicant: MILWAUKEE ELECTRIC TOOL CORPORATION, Brookfield, WI (US)

(72) Inventors: Muntather M. Alnasser, Sussex, WI (US); Timothy J. Bartlett, Waukesha, WI (US); Kyle R. Knight, Orland Park, IL (US); Robert J. Visher, Downers Grove, IL (US)

(21) Appl. No.: 18/820,685

(22) Filed: Aug. 30, 2024

Related U.S. Application Data
(60) Provisional application No. 63/586,468, filed on Sep. 29, 2023.
(60) Provisional application No. 63/579,927, filed on Aug. 31, 2023.

(51) Int. Cl. B23Q 11/00

(52) U.S. Cl. CPC B23Q 11/0082; B23Q 11/0092

(57) ABSTRACT

A power tool includes a housing, a handle coupled to the housing and configured to be grasped by a user during operation, a motor supported by the housing, a table, a mounting arm, and a controller. The table includes a sensing portion. The sensing portion includes a sensor. The sensing portion is configured to detect a body part of the user touching the table. The mounting arm supports the housing. The mounting arm is pivotably connected to the table and the housing. The controller is connected to the motor and the sensor. The controller is configured to receive a signal from the sensor related to whether the body part of the user is touching the table, and control operation of the motor in response to the sensing portion detecting that the body part of the user is touching the table.

### RELATED APPLICATIONS

This application claims the benefit of U.S. Provisional Patent Application No. 63/579,927, filed Aug. 31, 2023, and U.S. Provisional patent application No. 63/586,468, filed Sep. 29, 2023, the entire content of each of which is hereby incorporated by reference.

### FIELD

Embodiments described herein relate to power tools.

### SUMMARY

Power tools described herein include a housing, a handle coupled to the housing and configured to be grasped by a user during operation, a motor supported by the housing, a table, a mounting arm, and a controller. The table includes a sensing portion. The sensing portion includes a sensor. The sensing portion is configured to detect a body part of the user touching the table. The mounting arm supports the housing. The mounting arm is pivotably connected to the table and the housing. The controller is connected to the motor and the sensor. The controller is configured to receive a signal from the sensor related to whether the body part of the user is touching the table, and control operation of the motor in response to the sensing portion detecting that the body part of the user is touching the table.

Power tools described herein include a housing including a handle, the handle configured to be grasped by a user during operation, a first touch sensor disposed in the handle, a motor supported by the housing, the motor configured to drive a tool output, a second touch sensor disposed adjacent the tool output, and a controller connected to the first touch sensor, the second touch sensor, and the motor. The controller is configured to determine that the user is grasping the handle based on a first sensor signal from the first touch sensor, determine that flesh is not in proximity to the tool output based on a second sensor signal from the second touch sensor, and permit operation of the motor.

Power tools described herein include a housing, a handle coupled to the housing and configured to be grasped by a user during operation, a motor supported by the housing, a sensing portion including a sensor, the sensing portion configured to detect a body part of the user in proximity to the sensing portion, and a controller connected to the motor and the sensor. The controller configured to receive a signal from the sensor related to whether the body part of the user is in proximity to the power tool, and prohibit operation of the motor in response to detecting that the body part of the user is not in proximity to the sensing portion.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

### BRIEF DESCRIPTION OF THE DRAWINGS

FIG. 1 is a side view of a tabletop power tool, according to various embodiments.

FIG. 2 is a control system for the tabletop power tool of FIG. 1, according to various embodiments.

FIG. 3 illustrates a sensing circuit used in the tabletop power tool of FIG. 1, according to various embodiments.

FIG. 4 illustrates a flowchart for operating the tabletop power tool of FIG. 1 based on a signal from a sensor, according to various embodiments.

FIG. 5 is a perspective view of a power tool, according to various embodiments.

FIG. 6 is a cutaway view of the power tool of FIG. 5, according to various embodiments.

FIG. 7 is perspective view of a power tool, according to various embodiments.

FIG. 8 is a cutaway view of the power tool of FIG. 7, according to various embodiments.

FIG. 9 is perspective view of a power tool, according to various embodiments.

FIG. 10 is a control system for the power tool of FIG. 5 or FIG. 7, according to various embodiments.

FIG. 11 is a flowchart for operating the power tool of FIG. 5 based on signals from a plurality of sensors, according to various embodiments.

FIG. 12 is a flowchart for operating the power tool of FIG. 7 based on signals from a plurality of sensors, according to various embodiments.

### DETAILED DESCRIPTION

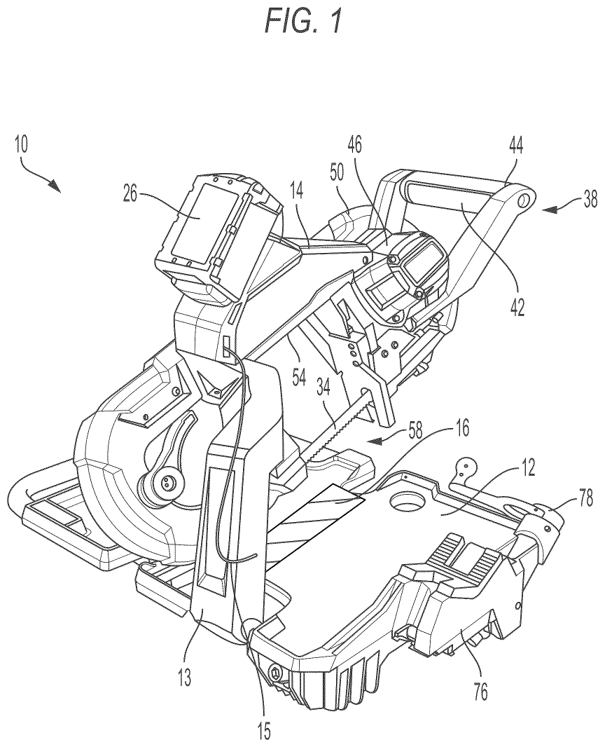

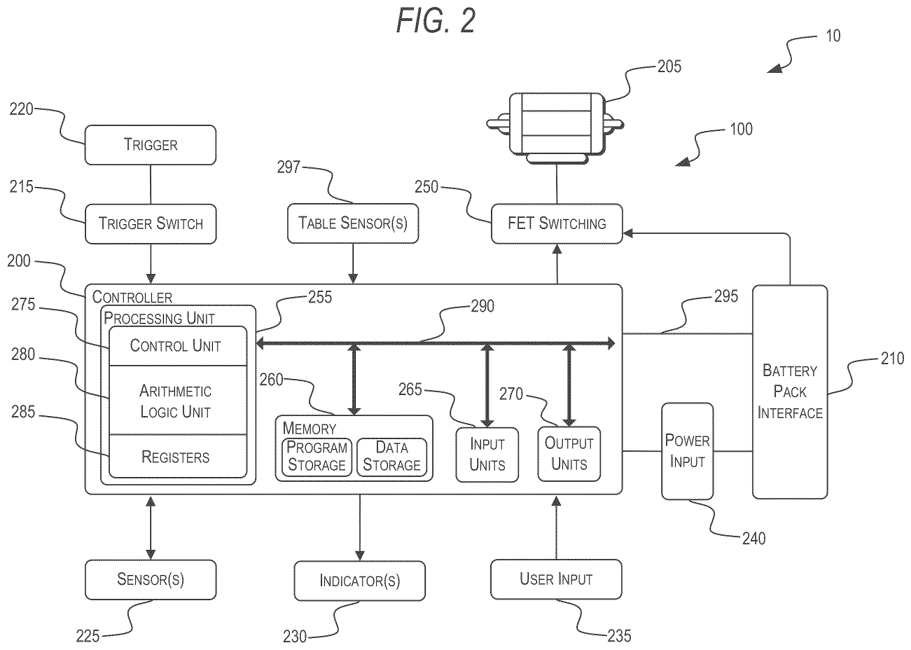

FIG. 1 illustrates a tabletop power tool 10 including a frame or housing 14. In the embodiment shown, the tabletop power tool 10 is a tabletop band saw pivotably mounted to a table 12 via mounting arm 13. The tabletop power tool 10 is configured to receive a removable and rechargeable battery pack 26 for supplying power to the tabletop power tool 10 for operation of the tabletop power tool 10. A motor 205 (see FIG. 2) is drivingly connected to a drive assembly of the tabletop power tool 10. The motor 205 and the drive assembly are supported by the housing 14. The drive assembly may include any of a number of bearing arrangements and different gear train arrangements configured to provide various speed and torque outputs. In the embodiment shown, the motor 205 and the drive assembly are operable to drive a continuous band saw blade 34 to cut a workpiece. The mounting arm 13 is configured to allow a user to bring the band saw blade 34 closer to and farther away from table 12 during operation for the purpose of cutting a workpiece.

In the embodiment shown, the housing 14 of the tabletop power tool 10 includes a primary handle 38 with a primary switch or primary trigger 42 to provide driving power via the motor 205 to a band saw blade 34. Specifically, the operation of the motor 205 is controlled based on an actuation of the primary trigger 42. The primary trigger 42 is disposed adjacent a gripping portion 44 of the primary handle 38 where a user grasps the tabletop power tool 10, and power is supplied from a battery 26 pack to the motor in response to an actuation of the primary trigger 42. The battery pack 26 is supported by the housing 14 and is an 18-volt power tool battery pack 26. In other embodiments, the battery pack 26 may be of a different voltage and supported on or in other parts of the tabletop power tool 10.

The housing 14 of the tabletop power tool 10 also includes a deck 46 and a guard 50 coupled to the deck 46. A combination of the deck 46 and the guard 50 defines an opening or cavity 54 (e.g., a U-shaped cavity). The guard 50 includes a lip that provides a recessed area in which the band saw blade 34 is positioned. The guard 50 substantially covers the band saw blade 34 when the blade 34 is in a shielded position (i.e., when the blade 34 is outside of a cut zone 58). The cavity 54 enables the band saw blade 34 to be in an exposed position (i.e., when the blade 34 passes through the cut zone 58). In the exposed position, the blade 34 is fully exposed and unobstructed by the guard 50, allowing workpieces to be cut when entering the cut zone 58.

An electrical conduit 15 electrically connects the tabletop power tool 10 to the mounting arm 13 and to the table 12. Table sensors 297 (see FIG. 2) associated with the table 12 (e.g., set into the table, directed at the table, directed across the table, etc.) are configured to communicate sensor signals to a controller of the tabletop power tool 10 (e.g., via conduit 15) in response to sensing a phenomenon related to the table 12 (e.g., a body part of a user is touching the table, the table has rotated, the table has shifted, the table has been bumped, etc.).

The table sensor 297 may include, for example, a touch sensor configured to detect whether a user is touching the tabletop power tool in an inappropriate or dangerous area (e.g., placing a hand on the table 12 in the sensing portion 16). In some embodiments, the table sensor 297 is a capacitive sensor disposed in the sensing portion 16 of the table 12. The capacitive sensor may include a sensing probe formed of unshielded wire routed from the controller 200 and coiled in a surface of the table 12 or in a surface of the tabletop power tool 10 to detect the presence of a body part of a user (e.g., an operator's hand). In some instances, the tabletop power tool 10 includes a reference capacitance (e.g., mounted on a printed circuit board) that can be used to mitigate or eliminate measurement drift due to common-mode environmental factors (e.g., temperature). In some instances, the capacitive sensor may also include a reference probe formed of a shielded copper pour configured to detect capacitance levels due to environmental conditions. In some embodiments, two or more capacitive sensors are integrated into the table 12 to detect an operator's hand. In some embodiments, the sensing portion 16 covers the entire worksurface of the table 12 (e.g., the surface of the table 12 configured to have a workpiece placed on it during operation of the tabletop power tool 10) or a portion of the housing 14. In some embodiments, the sensors 297 are microswitches that detect the presence of the user's hand on the table 12. In another embodiment, the sensors 297 are photolight sensors that are configured to detect the adjustment of light based on the position of the user's hand on the table 12 (e.g., no light detected may indicate hand presence). In some embodiments, the sensors 297 include a pressure sensor. It is contemplated that any combination of the aforementioned sensors may be used to sense a user placing a body part on the table 12 or touching the tabletop power tool 10 in an inappropriate area.

In some embodiments, the table 12 includes a projection 76 configured to support a workpiece to be engaged by the tabletop power tool 10 during operation. Table 12 may also include an adjusting knob 78 configured such that rotation of the adjusting knob adjusts a position of the projection 76.

FIG. 2 illustrates a control system 100 for the tabletop power tool 10. The control system 100 includes a controller 200. The controller 200 is electrically and/or communicatively connected to a variety of modules or components of the tabletop power tool 10. For example, the illustrated controller 200 is electrically connected to a motor 205, a battery pack interface 210, a trigger switch 215 (connected to a trigger 220), one or more sensors or sensing circuits 225, one or more indicators 230, a user input module 235, a power input module 240, and a FET switching module 250 (e.g., including a plurality of switching FETs). The controller 200 includes combinations of hardware and software that are operable to, among other things, control the operation of the tabletop power tool 10, monitor the operation of the tabletop power tool 10, activate the one or more indicators 230 (e.g., an LED), etc.

The controller 200 includes a plurality of electrical and electronic components that provide power, operational control, and protection to the components and modules within the controller 200 and/or the tabletop power tool 10. For example, the controller 200 includes, among other things, a processing unit 255 (e.g., a microprocessor, a microcontroller, an electronic processor, an electronic controller, or another suitable programmable device), a memory 260, input units 265, and output units 270. The processing unit 255 includes, among other things, a control unit 275, an arithmetic logic unit (“ALU”) 280, and a plurality of registers 285, and is implemented using a known computer architecture (e.g., a modified Harvard architecture, a von Neumann architecture, etc.). The processing unit 255, the memory 260, the input units 265, and the output units 270, as well as the various modules or circuits connected to the controller 200 are connected by one or more control and/or data buses (e.g., common bus 290). The use of one or more control and/or data buses for the interconnection between and communication among the various modules, circuits, and components would be known to a person skilled in the art in view of the embodiments described herein.

The memory 260 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 255 is connected to the memory 260 and executes software instructions that are capable of being stored in a RAM of the memory 260 (e.g., during execution), a ROM of the memory 260 (e.g., on a generally permanent basis), or another non-transitory computer readable medium such as another memory or a disc. Software included in the implementation of the tabletop power tool 10 can be stored in the memory 260 of the controller 200. The software includes, for example, firmware, one or more applications, program data, filters, rules, one or more program modules, and other executable instructions. The controller 200 is configured to retrieve from the memory 260 and execute, among other things, instructions related to the control processes and methods described herein. In other constructions, the controller 200 includes additional, fewer, or different components.

The motor 205 includes a rotor and a stator that surrounds the rotor. In some embodiments, the motor 205 is a brushless direct current (“BLDC”) motor in which the rotor is a permanent magnet rotor and the stator includes coil windings that are selectively energized to drive the rotor. In other embodiments, the motor is a brushed motor. In some embodiments, the motor 205 is an outer rotor motor. The stator is supported within the housing 14 and remains stationary relative to the housing 14 during operation of the tabletop power tool 10. The rotor is rotatably fixed to a rotor shaft and is configured to rotate with the rotor shaft, relative to the stator, about a motor axis. A portion of the rotor shaft is associated with or corresponds to the band saw blade 34 extending from the housing 14.

The battery pack interface 210 includes a combination of mechanical components (e.g., rails, grooves, latches, etc.) and electrical components (e.g., one or more terminals) configured to and operable for interfacing (e.g., mechanically, electrically, and communicatively connecting) the tabletop power tool 10 with a battery pack (e.g., battery pack 26). For example, power provided by the battery pack to the tabletop power tool 10 is provided through the battery pack interface 210 to the power input module 240. The power input module 240 includes combinations of active and passive components to regulate or control the power received from the battery pack prior to power being provided to the controller 200. The battery pack interface 210 also supplies power to the FET switching module 250 to provide power to the motor 205. The battery pack interface 210 also includes, for example, a communication line 295 for providing a communication line or link between the controller 200 and the battery pack 26.

The indicators 230 include, for example, one or more light-emitting diodes (“LEDs”). The indicators 230 can be configured to display conditions of, or information associated with, the tabletop power tool 10. For example, the indicators 230 are configured to indicate measured electrical characteristics of the tabletop power tool 10, the status of the tabletop power tool 10, whether the tabletop power tool is disabled, other fault conditions, etc. The user input module 235 is operably coupled to the controller 200 to, for example, select a forward mode of operation or a reverse mode of operation, a torque and/or speed setting for the tabletop power tool 10 (e.g., using torque and/or speed switches), etc. In some embodiments, the user input module 235 includes a combination of digital and analog input or output devices required to achieve a desired level of operation for the tabletop power tool 10, such as one or more knobs, one or more dials, one or more switches, one or more buttons, etc.

The controller 200 is configured to determine whether a fault condition of the tabletop power tool 10 is present and generate one or more control signals related to the fault condition. For example, the sensing circuits 225 include one or more current sensors, one or more speed sensors, one or more Hall Effect sensors, one or more temperature sensors, an accelerometer, a gyroscope, an inertial measurement unit [“IMU”], one or more pressure sensors, one or more object presence sensors (e.g., capacitive sensors, etc.), etc. The controller 200 calculates or includes, within memory 260, predetermined operational threshold values and limits for operation of the tabletop power tool 10. For example, when a potential thermal failure (e.g., of a FET, the motor 205, etc.) is detected or predicted by the controller 200, power to the motor 205 can be limited or interrupted until the potential for thermal failure is reduced. If the controller 200 detects one or more such fault conditions (e.g., a user's hand in the sensing portion 16) of the tabletop power tool 10 or determines that a fault condition of the tabletop power tool 10 no longer exists, the controller 200 is configured to provide information and/or control signals to another component of the tabletop power tool 10 (e.g. the battery pack interface 210, the indicators 230, etc.).

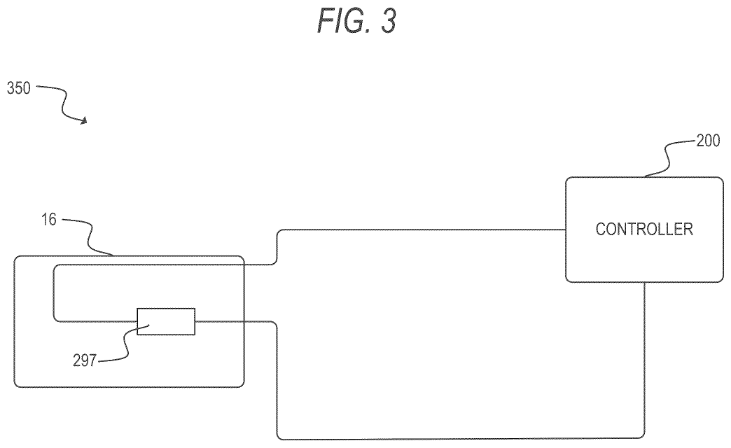

FIG. 3 illustrates a sensing circuit 350 used in the tabletop power tool 10, according to various embodiments. As described above, the sensing portion 16 may be configured to sense an object touching a worksurface of the table 12. In the embodiment shown, the sensor 297 is configured to communicate a sensor signal to controller 200 in response to detecting an object touching the table 12 at the sensing portion 16. In response to receiving the sensor signal, the controller 200 may control the operation of the tabletop power tool 10. For example, in the embodiment shown, if the sensor 297 detects a user touching the table 12 (e.g., with a body part) on either side of the band saw blade 34, the controller 200 may interrupt or disallow operation of the tabletop power tool 10. As another example, if the sensor 297 detects that a user is not touching the table 12 (e.g., with a body part) on either side of the band saw blade 34, the controller 200 may permit or allow operation of the tabletop power tool 10. It is contemplated that the sensing portion 16 may include multiple disjointed areas, and may encompass an area extending to both sides of the band saw blade 34 (e.g., to account for touching of the table 12 by both the left hand and right hand of the user). In various embodiments, the sensing portion 16 is a portion of the table 12 or tabletop power tool 10 between 1 square inch and 3 square feet. In various embodiments, the sensing portion 16 encompasses the entire table 12 of tabletop power tool 10 or a single surface of the table 12 or tabletop power tool 10.

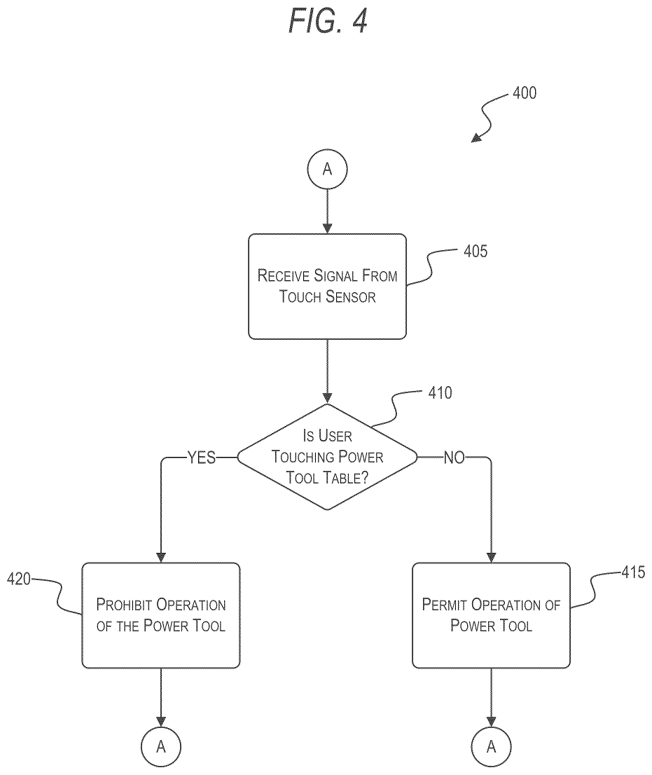

FIG. 4 is a flowchart 400 illustrating a method for operating a power tool based on a signal from a touch sensor. At block 405, a signal from the touch sensor (e.g., sensor 297) is received, for example, at the controller 200. At block 410 a determination is made, for example, by the controller 200, as to whether a user of the power tool 10 is touching a table (e.g., table 12) associated with the power tool 10 or otherwise inappropriately touching the tabletop power tool 10. If it is determined that the user is not touching the table 12 or otherwise inappropriately touching the power tool 10, the process proceeds to block 415, and operation of the power tool 10 is permitted, for example, by the controller 200, to operate the motor 205. However, if it is determined that the user is touching the table 12 or is otherwise inappropriately touching the power tool 10, the process proceeds to block 420, and operation of the power tool 10 is prohibited, for example, by the controller 200. After block 415 or block 420 is reached and executed, the process returns to block 405, where another signal from the touch sensor (e.g., sensor 297) is received.

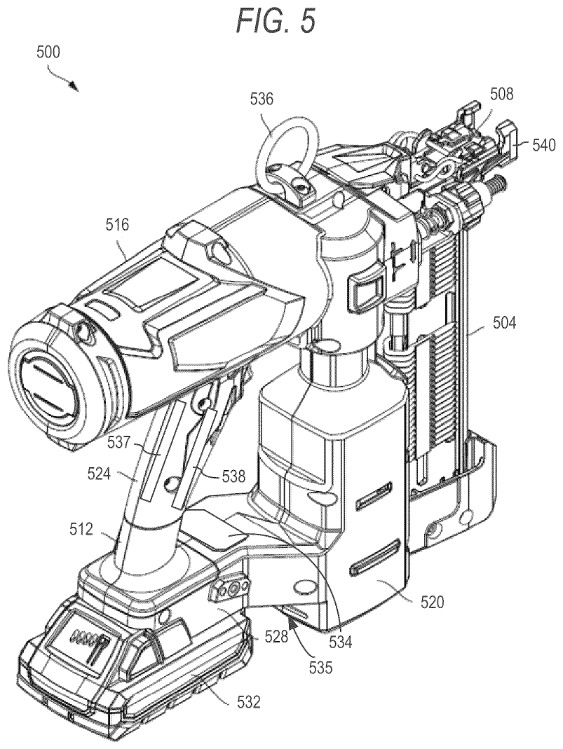

FIG. 5 illustrates a perspective view of a power tool 500. In the embodiment shown, the power tool 500 is a powered fastener driver (e.g., a fencing stapler). In other embodiments, the power tool 500 may be, for example, a reciprocating saw, a drill, a circular saw, a jigsaw, a band saw, a screwdriver, an angle or straight grinder, a hammer drill, an impact wrench, etc. In such embodiments, the power tool 500 may be operable to oscillate, rotate, reciprocate, or otherwise drive other types of output elements such as drill bits, saw blades, and the like. The power tool 500 shown is configured to drive/fire fasteners held within a magazine 504 into a workpiece. The fastener driver includes a nosepiece 508, a workpiece contact element 509, and a housing 512. The housing 512 includes a first or cylinder housing portion 516, a second or motor housing portion 520 extending from the cylinder housing portion 516, a handle portion 524 extending from the cylinder housing portion 516, and a battery pack interface 528 located on an opposite end of the handle portion 524. The battery pack interface 528 is configured to receive a removable and rechargeable battery pack 532. A hog ring or tether 536 may be coupled to the housing 512. The tether 536 may be coupled to a lanyard or the like to connect the driver to the user.

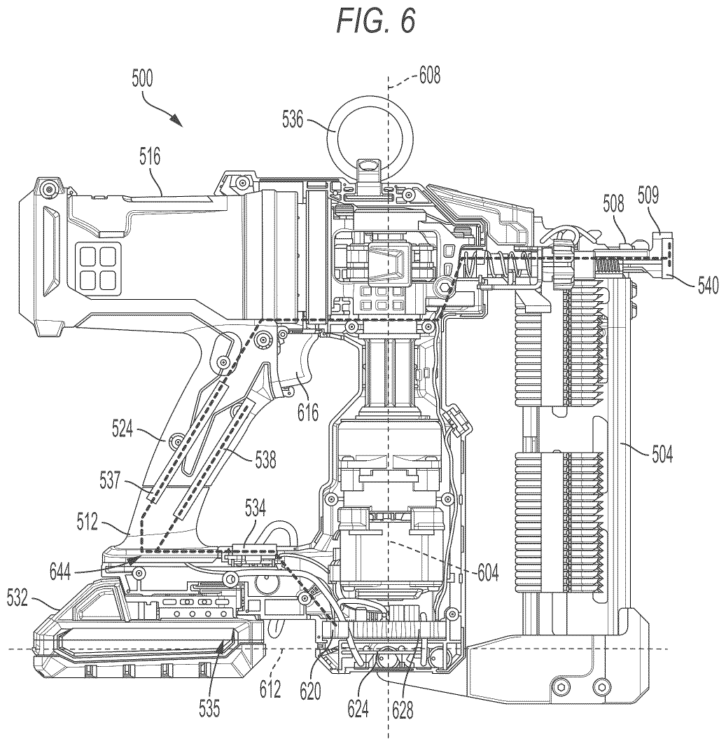

FIG. 6 illustrates a side section view of the power tool 500, with portions of the housing 512 removed. The motor housing portion 520 is configured to support a motor 604. The motor 604 defines a motor axis 608 through the motor housing portion 520. The battery pack 532 is electrically connectable to the power tool 500 for supplying electrical power to the motor 604. The battery pack interface 528 defines a battery pack insertion axis 612 that is, for example, perpendicular to the motor axis 608. The handle portion 524 supports a trigger 616, which is configured to be depressed by a user to initiate a firing cycle of the fastener driver.

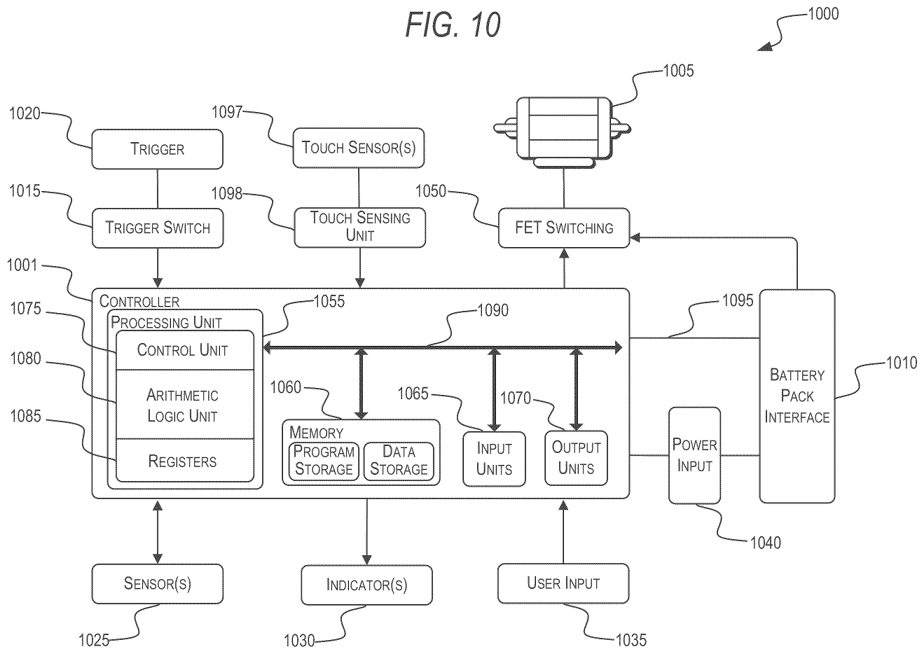

The motor housing portion 520 is further configured to support a first printed circuit board 620 and a second printed circuit board 624. The second printed circuit board 624 is separate from the first printed circuit board 620, but can be electrically connected to the first printed circuit board. The first printed circuit board 620 includes, for example, a controller (see FIG. 10), one or more switches (e.g., FETs), etc. In some embodiments, the first printed circuit board 620 is mounted to or otherwise in thermal communication with a heat sink 628.

In the embodiment shown, a sensor 534 is disposed on a base portion 535 of the power tool 500, sensors 537, 538 are disposed on or in the handle portion 524, and sensor 540 is disposed on or adjacent to the nosepiece 508 of the power tool 500. In some embodiments, sensors 537, 538 are disposed inside the handle portion 524. For example, sensors 537, 538 may be disposed in one or more wire routing channels near a seam of the two halves of the handle portion (e.g., running along a seam of the handle portion 524 between the trigger 616 and the base portion 535, or along the pack of the handle portion 524). Sensors 537, 538 may also be mounted to the surface of handle portion 524 (e.g., as printed circuit boards, flexible printed circuit boards copper shims, or foils). In some embodiments, the sensor 540 are laid along the inside surface of the nosepiece 508. In some embodiments, sensors 540 are embedded in the nosepiece 508, mounted on the front surface of the nosepiece 508, etc., (e.g., as printed circuit boards, flexible printed circuit boards copper shims, or foils). Sensors 534, 537, 538, 540 may be configured to detect when flesh contacts them, or when flesh contacts a portion of the power tool 500 on which or in which the sensors 534, 537, 538, 540 are disposed. For example, sensor 534 may be configured to sense a user touching the base portion 535, sensors 537, 538 may be configured to sense when a user is touching the handle portion 524, and sensor 540 may be configured to determine when a user touches the nosepiece 508. In the embodiment shown, the workpiece contact element 509 is movable with respect to the nosepiece 508 between an extended position and a retracted position. The workpiece contact element 509 moves from the extended position to the retracted position when the workpiece contact element 509 contacts a workpiece and a force directed toward the workpiece is applied to the power tool 500. The workpiece contact element 509 may also be configured as a guide member when driving a fastener into a workpiece. In one example, the workpiece contact element 509 may facilitate a user aligning a driving axis of the power tool 500 in a direction transverse to a wire member positioned adjacent the workpiece. The power tool 500 may be configured to allow a firing of a fastener in response to the workpiece contact element 509 being in the retracted position, and to prevent firing of a fastener in the extended position. In some embodiments, the sensor 540 can be mounted to the workpiece contact element 509. In further embodiments, the sensor 540 is the workpiece contact element 509 such that if the user is touching anywhere along the length of the workpiece contact element 509, the power tool 500 will prevent firing of a fastener.

As will be described in greater detail below, sensors 534, 537, 538, 540 may also be configured to sense the proximity of flesh in addition to sensing touches by flesh.

In the embodiment shown, wiring 644 electrically connects the sensors 534, 537, 538, 540 to the printed circuit board 620. Each of the sensors 534, 537, 538, 540 may be associated with an electrode and may be configured in a self-sensing mode or a mutual mode. For example, sensors 537, 538 may each be configured to produce a sensor signal in a self-sensing mode, or may be configured to produce a co-dependent signal in a mutual mode (e.g., both sensors 537, 538 must detect a touch by flesh contemporaneously in order for either of the sensors 537, 538 to produce a sensor signal indicating that a touch by flesh was detected). In some embodiments, at least one of the sensors 537 and 538 are set up in mutual mode with sensor 540, such that a signal is not produced unless both sensors detect flesh. Sensor signals produced by sensors 534, 537, 538, 540 are communicated to the circuit board 620 for processing via wiring 644.

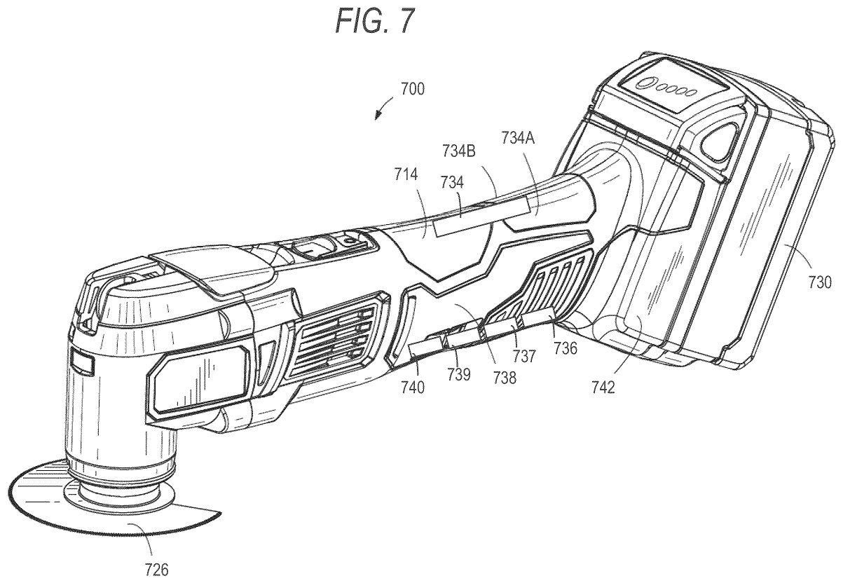

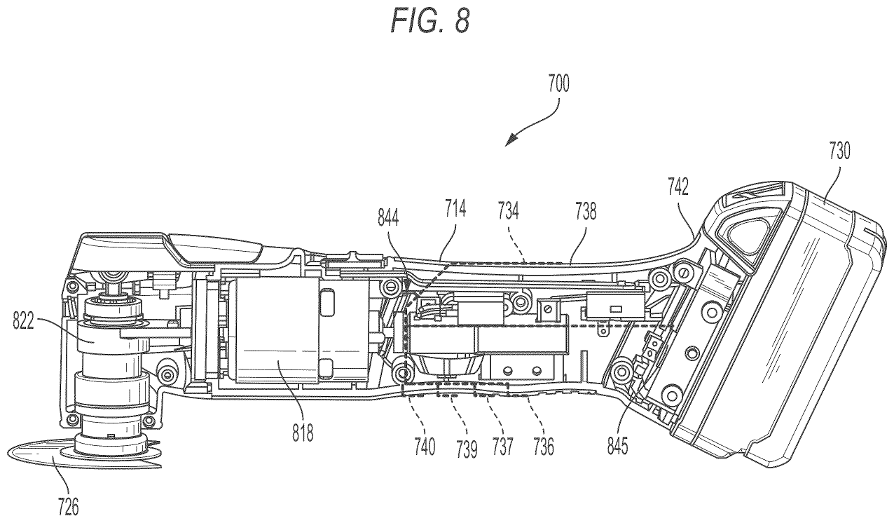

FIGS. 7 and 8 illustrate a power tool 700. The illustrated power tool 700 is a multi-tool operable to oscillate a cutting blade, a scraping blade, a sanding sheet, and the like. In other embodiments, the power tool 700 may be, for example, a reciprocating saw, a drill, a circular saw, a jigsaw, a band saw, a screwdriver, an angle or straight grinder, a hammer drill, an impact wrench, etc. In such embodiments, the power tool 700 may be operable to oscillate, rotate, reciprocate, or otherwise drive other types of output elements such as drill bits, saw blades, and the like.

The illustrated power tool 700 includes a housing 714, a motor 818, a drive mechanism 822, an output element 726, and a battery pack 730. The housing 714 includes two clamshell halves 734A, 734B that are connected together to enclose the motor 818 and the drive mechanism 822. When connected together, the clamshell halves 734A, 734B define a grip portion 738 and a battery support portion 742 of the housing 714. The grip portion 738 is configured to be grasped by a user during operation of the power tool 700. The battery support portion 742 is configured to indirectly support the battery pack 730 on the housing 714, as further described below.

As shown in FIG. 8, the motor 818 and the drive mechanism 822 are positioned substantially within the housing 714 in front of the grip portion 738. In some embodiments, the drive mechanism 822 is positioned within a gear case inside of and/or supported by the housing 714. The drive mechanism 822 is coupled to the motor 818 to be driven by the motor 818. When energized, the motor 818 drives the drive mechanism 822 to oscillate the output element 726.

The output element 726 is coupled to an output shaft or spindle of the drive mechanism 822. The illustrated output element 726 is located at an opposite end of the housing 714 from the battery pack 730, but may alternatively be located in other locations on the housing 714 relative to the battery pack 730. In the illustrated embodiment, the output element 726 is a cutting blade that is oscillated during operation of the power tool 700. In other embodiments, the output element 726 may be a different type of element (e.g., a scraping blade, a sanding sheet, etc.) and/or may be driven in a different manner (e.g., rotated, reciprocated, etc.) by the drive mechanism 822.

The battery pack 730 is supported at the battery support portion 742 of the housing 714 and electrically coupled to the motor 818. During operation of the power tool 700, the battery pack 730 supplies power to the motor 818 to energize the motor 818. The illustrated battery pack 730 is an 58 volt Li-ion power tool battery pack. In other embodiments, the battery pack 730 may have different voltages (e.g., 12 volts, 14.4 volts, 28 volts, etc.) and/or chemistries (e.g., NiCd, NiMH, etc.).

In the embodiment shown, a plurality of sensors 734, 736, 737, 739, 740 is disposed on or in the grip portion 738. Sensors 734, 736, 737, 739, 740 may be disposed in one or more wire routing channels (not shown) near a seam of the two halves of the housing 714 (e.g., running along the back of grip portion 738). Sensors 734, 736, 737, 739, 740 may also be mounted to the surface of handle portion 524 (e.g., as printed circuit boards, flexible printed circuit boards copper shims, or foils). Sensors 734, 736, 737, 739, 740 may be configured to detect when flesh contacts them, or when flesh contacts a portion of the power tool 700 on which or in which the sensors 734, 736, 737, 739, 740 are disposed. For example, sensors 734, 736, 737, 739, 740 may be configured to sense when a user is touching the grip portion 738. As will be described in greater detail below, sensors 734, 736, 737, 739, 740 may also be configured to sense the proximity of flesh in addition to sensing touches by flesh.

In the embodiment shown, wiring 844 electrically connects the sensors 734, 736, 737, 739, 740 to a circuit board 845 including a controller (see FIG. 10). Each of the sensors 734, 736, 737, 739, 740 may be associated with an electrode and may be configured in a self-sensing mode or a mutual mode. For example, sensors 736, 737, 739, 740 may each be configured to produce a sensor signal in a self-sensing mode, or may be configured to produce a co-dependent signal in a mutual mode (e.g., all sensors 736, 737, 739, 740 must detect a touch by flesh contemporaneously in order for any of the sensors 736, 737, 739, 740 to produce a sensor signal indicating that a touch by flesh was detected). Sensor signals produced by sensors 734, 736, 737, 739, 740 are communicated to the circuit board 845 for processing via wiring 844.

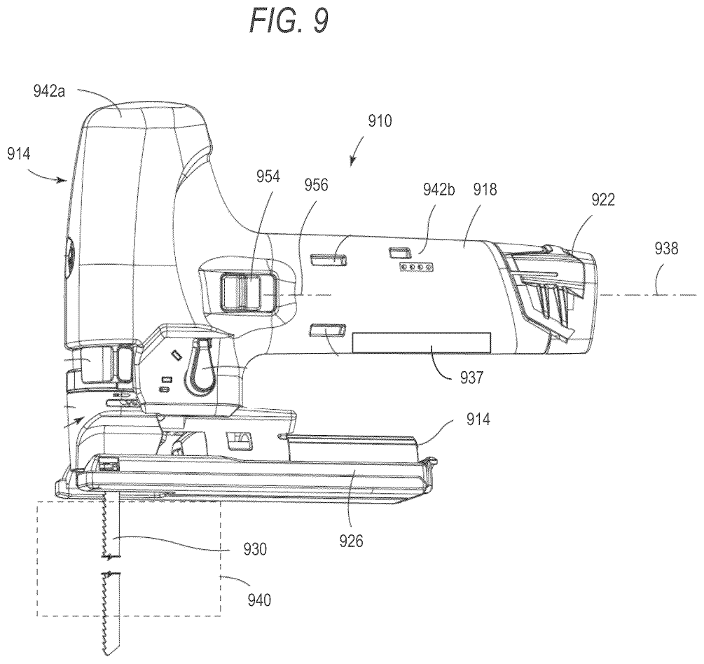

FIG. 9 illustrates a jigsaw 910, including a housing 914, a handle 918 extending from the housing 914 in a generally transverse direction, a battery pack 922 removably coupled to the handle 918, a foot plate 926 pivotably coupled to the housing 914 and configured to contact a workpiece during a cutting operation, and a cutting blade 930 protruding from the housing 914 and the lower surface of the foot plate 926. The jigsaw 910 includes a drive assembly powered by the battery pack 922 and operable to impart reciprocating motion to the cutting blade 930 for cutting of a workpiece. The jigsaw 910 defines a handle axis 938 extending in the direction of the handle 918. Moreover, the cutting blade 930 generally reciprocates within a blade plane 940 during a cutting operation.

In the embodiment shown, the handle 918 receives the battery pack 922 along the handle axis 938 and supports a controller (see FIG. 10). The controller is disposed between the battery pack 922 and the drive assembly in a direction along the handle axis 938. The jigsaw 910 also includes gripping surfaces 942a, 942b disposed on the housing 914 and the handle 918, respectively, that are graspable by a user to operate and maneuver the jigsaw 910 relative to a workpiece. The gripping surfaces 942a, 942b, in addition to the housing 914 and the handle 918, are composed of a non-conductive material (e.g., plastic with or without an elastomeric overmold). Such a non-conductive material electrically insulates the user should the user inadvertently cut an electrical wire during a cutting operation, thus inhibiting, or at least mitigating, an electrical shock.

In the embodiment shown, the jigsaw 910 further includes an activation switch 954 in electrical communication with the controller to selectively supply power to the drive assembly. Specifically, the activation switch 954 provides an input to the controller which, in turn, instructs the battery pack 922 to supply power to the drive assembly. The activation switch 954 is provided adjacent the handle 918. The activation switch 954 is slidable between an activated state, in which the battery pack 922 supplies power to the drive assembly, and a deactivated state, in which the drive assembly is deactivated. The activation switch 954 is slidable along a switch axis 956 that is, for example, parallel to the handle axis 938 of the jigsaw 910.

A sensor 937 is shown disposed on the handle 918. Although shown disposed on the handle 918, sensor 937 may be disposed anywhere on the jigsaw 910. Sensor 937 may be configured to detect when flesh contacts it, or when flesh contacts a portion of the jigsaw 910 on which or in which the sensor 937 is disposed. For example, sensor 937 may be configured to sense when a user is touching the handle 918, and an additional sensor may be configured to sense when a user is touching the foot plate 926 of the jigsaw 910.

FIG. 10 illustrates a control system 1000 for the power tool 500, 700. The control system 1000 includes a controller 1001. The controller 1001 is electrically and/or communicatively connected to a variety of modules or components of the power tool 500, 700. For example, the illustrated controller 1001 is electrically connected to a motor 1005, a battery pack interface 1010, a trigger switch 1015 (connected to a trigger 1020), one or more sensors or sensing circuits 1025, one or more indicators 1030, a user input module 1035, a power input module 1040, and a FET switching module 1050 (e.g., including a plurality of switching FETs). The controller 1001 includes combinations of hardware and software that are operable to, among other things, control the operation of the power tool 500, 700, monitor the operation of the power tool 500, 700, activate the one or more indicators 1030 (e.g., an LED), etc.

The controller 1001 includes a plurality of electrical and electronic components that provide power, operational control, and protection to the components and modules within the controller 1001 and/or the power tool 500, 700. For example, the controller 1001 includes, among other things, a processing unit 1055 (e.g., a microprocessor, a microcontroller, an electronic processor, an electronic controller, or another suitable programmable device), a memory 1060, input units 1065, and output units 1070. The processing unit 1055 includes, among other things, a control unit 1075, an arithmetic logic unit (“ALU”) 1080, and a plurality of registers 1085, and is implemented using a known computer architecture (e.g., a modified Harvard architecture, a von Neumann architecture, etc.). The processing unit 1055, the memory 1060, the input units 1065, and the output units 1070, as well as the various modules or circuits connected to the controller 1001 are connected by one or more control and/or data buses (e.g., common bus 1090). The use of one or more control and/or data buses for the interconnection between and communication among the various modules, circuits, and components would be known to a person skilled in the art in view of the embodiments described herein.

The memory 1060 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 1055 is connected to the memory 1060 and executes software instructions that are capable of being stored in a RAM of the memory 1060 (e.g., during execution), a ROM of the memory 1060 (e.g., on a generally permanent basis), or another non-transitory computer readable medium such as another memory or a disc. Software included in the implementation of the power tool 500, 700 can be stored in the memory 1060 of the controller 1001. The software includes, for example, firmware, one or more applications, program data, filters, rules, one or more program modules, and other executable instructions. The controller 1001 is configured to retrieve from the memory 1060 and execute, among other things, instructions related to the control processes and methods described herein. In other constructions, the controller 1001 includes additional, fewer, or different components.

The motor 1005 includes a rotor and a stator that surrounds the rotor. In some embodiments, the motor 1005 is a brushless direct current (“BLDC”) motor in which the rotor is a permanent magnet rotor and the stator includes coil windings that are selectively energized to drive the rotor. In other embodiments, the motor is a brushed motor. The stator is supported within the housing 512, 714 and remains stationary relative to the housing 512, 714 during operation of the power tool 500, 700. The rotor is rotatably fixed to a rotor shaft and configured to rotate with the rotor shaft, relative to the stator, about a motor axis. A portion of the rotor shaft is associated with or directly drives an output of the power tool 500, 700 (e.g., a firing cycle of power tool 500, or a movement of the output element 726 of power tool 700). In some embodiments, the motor 1005 is an outer rotor motor.

The battery pack interface 1010 includes a combination of mechanical components (e.g., rails, grooves, latches, etc.) and electrical components (e.g., one or more terminals) configured to and operable for interfacing (e.g., mechanically, electrically, and communicatively connecting) the power tool 500, 700 with a battery pack. For example, power provided by the battery pack to the power tool 500, 700 is provided through the battery pack interface 1010 to the power input module 1040. The power input module 1040 includes combinations of active and passive components to regulate or control the power received from the battery pack prior to power being provided to the controller 1001. The battery pack interface 1010 also supplies power to the FET switching module 1050 to provide power to the motor 1005. The battery pack interface 1010 also includes, for example, a communication line 1095 for providing a communication line or link between the controller 1001 and the battery pack.

The indicators 1030 include, for example, one or more light-emitting diodes (“LEDs”). The indicators 1030 can be configured to display conditions of, or information associated with, the power tool 500, 700. For example, the indicators 1030 are configured to indicate measured electrical characteristics of the power tool 500, 700, the status of the power tool 500, 700, etc. The user input module 1035 is operably coupled to the controller 1001 to, for example, select a forward mode of operation or a reverse mode of operation, a torque and/or speed setting for the power tool 500, 700 (e.g., using torque and/or speed switches), etc. In some embodiments, the user input module 1035 includes a combination of digital and analog input or output devices required to achieve a desired level of operation for the power tool 500, 700, such as one or more knobs, one or more dials, one or more switches, one or more buttons, etc.

The controller 1001 is configured to determine whether a fault condition of the power tool 500, 700 is present and generate one or more control signals related to the fault condition. For example, the sensing circuits 1025 include one or more current sensors, one or more speed sensors, one or more Hall Effect sensors, one or more temperature sensors, an accelerometer, a gyroscope, an inertial measurement unit [“IMU”], one or more pressure sensors, one or more object presence sensors, etc. The controller 1001 calculates or includes, within memory 1060, predetermined operational threshold values and limits for operation of the power tool 500, 700. For example, when a potential thermal failure (e.g., of a FET, the motor 1005, etc.) is detected or predicted by the controller 1001, power to the motor 1005 can be limited or interrupted until the potential for thermal failure is reduced. If the controller 1001 detects one or more such fault conditions of the power tool 500, 700 or determines that a fault condition of the power tool 500, 700 no longer exists, the controller 1001 is configured to provide information and/or control signals to another component of the power tool 500, 700 (e.g. the battery pack interface 1010, the indicators 1030, etc.).

Touch sensors 1097 (e.g., sensors 534, 537, 538, 540, 734, 736, 737, 739, 740, etc.) may be disposed anywhere on the power tool 500, 700, and are configured to detect that flesh is either proximate to or touching a part of the power tool 500, 700. For example, touch sensors 1097 may be disposed on a handle or grip (e.g., grip portion 738) of the power tool 500, 700, a guard (e.g., a blade guard of a bandsaw) of the power tool 500, 700, a portion of the power tool 500, 700 associated with an output (e.g., nosepiece 508) of the power tool 500, 700, or a portion of the power tool 500, 700 associated with a user interface (e.g., base portion 535) of the power tool 500, 700. Touch sensors 1097 may be configured to sense a touch from flesh, or a proximity of flesh. Accordingly, touch sensors 1097 may include a capacitive sensor (e.g., a surface capacitance sensor or a projected capacitance sensor), a pressure sensor (e.g., a resistive sensor), a light sensor (e.g., a photo resistor), or any other sensor configured to detect flesh or configured to determine when the sensor is being covered (e.g., by a hand of a user). Each of the sensors 1097 may have two thresholds set. A first threshold may be a proximity detection threshold, and a second threshold may be a touch detection threshold. The proximity threshold may be set as a percent deviation from a set count value. The count value may be a raw data value representing a sensed electrical phenomenon (e.g., a change in capacitance) produced by a sensor (e.g., by a capacitive touch sensor, at regular intervals). The proximity threshold may be chosen as a percent deviation from the long term average (“LTA”) of this count value. An absolute proximity threshold may also be determined as an absolute deviation from the LTA. This absolute deviation may specify how large the deviation must be in the direction of interest for a proximity state to be declared.

The absolute proximity threshold may be set for a self-sensing mode of a sensor by subtracting the proximity threshold from the LTA, and for a mutual-sensing mode of a sensor by adding the proximity threshold from the LTA:

$${ProxThresh}_{absolute} = \{ \begin{matrix}Self : & L T A - {ProxThresh}_{programmed} \\ Mutual : & L T A + {ProxThresh}_{programmed}\end{matrix}$$

A touch threshold may also be set for the sensors 1097. The touch threshold sets the level of interaction required by the user for a touch detection to be declared for the sensors 1097. Unlike the proximity threshold, the effective touch threshold may be dynamic, and may be set as a deviation from the long term average (“LTA”), in units of 1/128 of the LTA. By defining the touch threshold as a percentage of the LTA, it is possible to maintain a consistent sensitivity even if the LTA drifts due to a changing environment (e.g., a change in temperature, a change in moisture level due to rain/snow, an introduction random materials coming in contact with tool/sensors, etc.). A touch threshold is set by taking the result from the product of the LTA and the set threshold and then dividing by, for example, a set value (e.g., 128):

$${TouchThresh}_{absolute} = \{ \begin{matrix}Self : & L T A - ( \frac{L T A}{128} {TouchThresh}_{programmed} ) \\ Mutual : & L T A + ( \frac{L T A}{128} {TouchThresh}_{programmed} )\end{matrix}$$

In some embodiments, power tool 500 is configured such that the ability to initiate an operation cycle (e.g., to drive a fastener into a workpiece) is disabled by the controller 1001 if, for example, flesh is detected by sensor 540. Additionally power tool 500 may be configured such that the ability to initiate an operation cycle is enabled by the controller 1001 only if, for example, no flesh is detected at sensor 540, at least one of sensors 537, 538 detects flesh, and nosepiece 508 is depressed, indicating that the power tool 500 is pressed against a workpiece. In some embodiments, at least one of sensors 537, 538 is configured to send controller 1001 a wake signal and accordingly permit operation of the power tool 500. To that end, in some embodiments, trigger 616 is disabled from causing a movement of the motor 1005 unless such a wake signal is received at the controller 1001. In some embodiments, sensor 534 is configured to produce signals configured to control the power state of the tool and firing mode in response to user input received via the sensor 1097. For example, in some embodiments pressing and holding sensor 534 for a certain amount of time (e.g., 2-5 seconds) causes the sensor 534 to produce a power-off signal to turn off the tool if the tool is on. In some embodiments, if the tool is off, pressing and holding sensor 534 for a certain amount of time (e.g., 2-5 seconds) causes the sensor 534 to produce a power-on signal turn on the tool. Controller 1001 receives these signals and controls the power state of the power tool 500 accordingly. In some embodiments, sensor 534 is configured to produce signals that cause the controller 1001 to change the operating mode of the power tool 500 (e.g., the operating speed of the motor 1005, the trigger event for causing the motor to move, etc.). For example, in some embodiments, pressing sensor 534 a predetermined number of times (e.g., 2-7 times) rapidly in quick succession (e.g., each press within 0.2-0.7 seconds of the prior press) will switch to an alternative firing mode.

In some embodiments, power tool 700 is configured such that the operating mode of motor 1005 is controlled according to a user's interaction with sensors 734, 736, 737, 739, 740. For example, the controller 1001 may be configured to change an operating mode (e.g., the operating speed of the motor 1005, the trigger event for causing the motor to drive the rotor, etc.) of the power tool 700 in response to a user touching the sensors 734, 736, 737, 739, 740 according to a predefined pattern (e.g., a predefined gesture). In some embodiments, the controller 1001 is configured to enable or disable operation of the motor 1005 in response to a user touching the sensors 734, 736, 737, 739, 740 according to a predefined pattern (e.g., a predefined gesture). In some embodiments, indicators 1030 are configured to indicate that a predefined pattern of touches has been sensed and recognized by the controller 1001. In some embodiments, swiping across the sensors 736, 737, 739, 740 along a first direction causes the controller 1001 to increase the operating speed of the motor 1005, while swiping across the sensors 736, 737, 739, 740 along a second direction causes the controller 1001 to decrease the operating speed of the motor 1005. In these embodiments, a swipe across the sensors 736, 737, 739, 740 may be detected discretely as a plurality of sequentially sensed touches or cooperatively as a plurality of sensed proximities. Further, sensors 736, 737, 739, 740 may operate essentially as a single sensor (e.g., an operating mode selection sensor, a slider, etc.). In some embodiments, sensor 734 is configured to send a wake signal to controller 1001 in response to detecting flesh, and the controller 1001 is configured to enable operation of motor 1005 in response to the wake signal. In some embodiments, a particular pattern of activation is required in order to prevent unintended operational changes using the sensors 736, 737, 739, and 740.

In some embodiments, the sensors 1097 do not interact directly with the tool controller 1001. The touch sensors 1097 are instead charged, measured, and managed by an intermediary touch sensing unit 1098 (e.g., a second MCU). The touch sensing unit 1098 may be a microcontroller distinct from the controller 1001, and configured to communicate with the sensors 1097 and the controller 1001. In such embodiments, the touch sensing unit 1098 may be configured to receive a sensor signal and produce a count value based on the sensor signal, then communicate the count value to the controller 1001. In some embodiments, the touch sensing unit 1098 is configured to communicate a digital signal to the controller in response to an analog signal received from the sensors 1097. In such embodiments, the controller 1001 may take action in response to a communication from the touch sensing unit 1098. For example, the controller 1001 may disable the trigger 1020 in response to a count value communicated to it by the touch sensing unit. In embodiments not including the touch sensing unit 1098, the same functionality can be performed by the controller 1001.

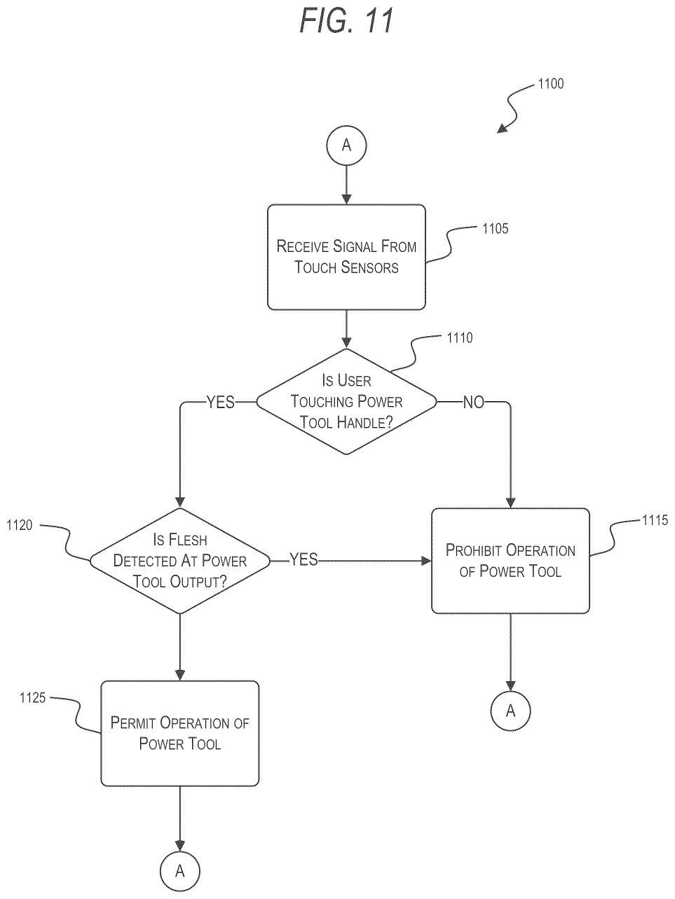

FIG. 11 is a flowchart 1100 for operating power tool 500 based on signals from the touch sensors 1097. At block 1105, the controller 1001 receives signals from the touch sensors 1097 (e.g., signals indicating that flesh is or is not touching a particular sensor, flesh is or is not proximate to a particular sensor, etc.). At least one of these signals may include a wake signal for controller 1001.

At block 1110, the controller 1001 determines, based on the signals received from the touch sensors 1097, whether a user is touching the handle portion 524 of power tool 500. If, the controller 1001 determines that a user is not touching the handle portion 524, the process proceeds to block 1115. If, however, the controller 1001 determines that a user is touching the handle portion 524, the process proceeds to block 1120.

At block 1115, the controller prohibits operation of the power tool 500. In some embodiments, prohibiting operation of the power tool 500 involves prohibiting the motor 1005 from moving (e.g., rotating). In some embodiments, prohibiting operation of the power tool 500 includes prohibiting all electrically powered functions of the power tool 500.

At block 1120, the controller determines whether flesh is detected at an output element (e.g., nosepiece 508) of the power tool 500, based on the sensor signals received from the touch sensors 1097. If the controller 1001 determines that flesh is detected at the output element, the process proceeds to block 1115 where operation of the power tool 500 is prohibited. However, if the controller 1001 determines that flesh is not detected at the output element of the power tool 500, the process proceeds to block 1125.

At block 1125, the controller permits operation of the power tool 500. In some embodiments, permitting operation of the power tool 500 involves permitting the motor 1005 to move (e.g., rotate). In some embodiments, permitting operation of the power tool 500 includes permitting all electrically powered functions of the power tool 500.

In some embodiments, if a user has turned on the power tool 500 and not yet selected a mode/speed for the power tool 500, the power tool 500 defaults to the last set mode/speed. For example, if the user temporarily turns off the power tool 500 and sets it aside, the power tool 500 may be configured to return to the last operating state it was set to if sensors 1097 sense that the user has picked the power tool 500 back up within a predetermined period of time.

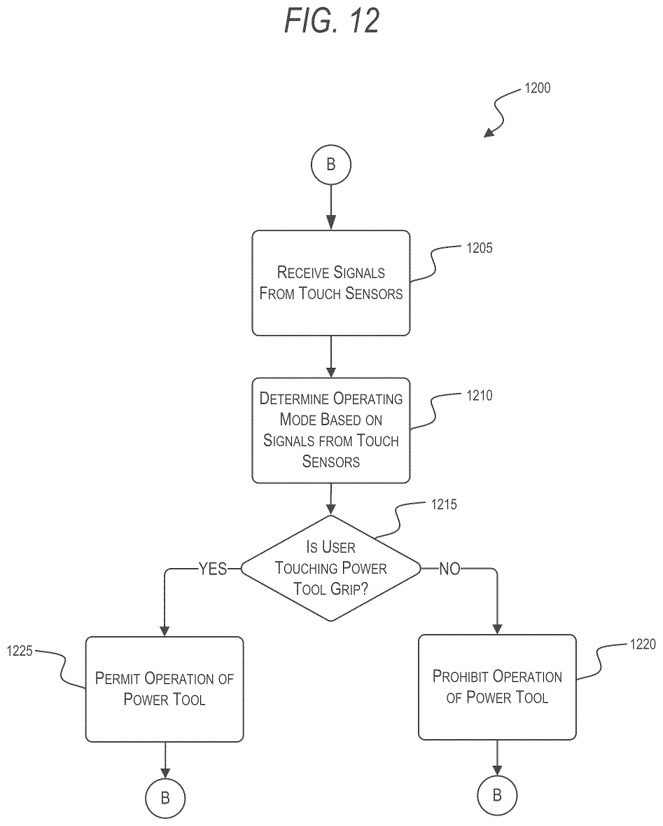

FIG. 12 is a flowchart 1200 for operating power tool 700 based on signals from the touch sensors 1097. At block 1205, the controller 1001 receives signals from the touch sensors 1097 (e.g., that a user is contacting the grip portion 738, etc.). At least one of these signals may include a wake signal for controller 1001.

At block 1210, the controller 1001 determines, based on the signals received from the touch sensors 1097, the operating mode of the power tool 700. For example, the controller 1001 may determine the speed or torque at which motor 1005 should be operated. The controller 1001 may also determine whether changes to the operating speed of the motor 1005 should be enabled or disabled. The controller may also determine whether any predefined patterns (e.g., gestures) have been input by a user via the touch sensors 1097.

At block 1215, the controller determines, based on the sensor signals, whether a user is touching, for example, the grip portion 738 of the power tool 700. If the controller 1001 determines that a user is not touching the grip portion 738, the process proceeds to block 1220. If, however, the controller 1001 determines that a user is touching the grip portion 738, the process proceeds to block 1225.

At block 1220, the controller 1001 prohibits operation of the power tool 700. In some embodiments, prohibiting operation of the power tool 700 involves prohibiting the motor 1005 from moving (e.g., rotating). In some embodiments, prohibiting operation of the power tool 700 includes prohibiting all electrically powered functions of the power tool 700.

At block 1225, the controller permits operation of the power tool 700 (e.g., according to a selected operation mode from the touch sensors 1097). In some embodiments, permitting operation of the power tool 700 involves permitting the motor 1005 to move (e.g., rotate). In some embodiments, permitting operation of the power tool 700 includes permitting all electrically powered functions of the power tool 700.

Although the invention has been described in detail with reference to certain preferred embodiments, variations and modifications exist within the scope and spirit of one or more independent aspects of the invention as described. Various features and advantages are set forth in the following claims.

What is claimed is:

1. A power tool comprising:
a housing;
a handle coupled to the housing and configured to be grasped by a user during operation;
a motor supported by the housing;
a table including a sensing portion, the sensing portion including a sensor, the sensing portion configured to detect a body part of the user in proximity to the table;
a mounting arm supporting the housing, the mounting arm pivotably connected to the table and the housing; and
a controller connected to the motor and the sensor, the controller configured to:
receive a signal from the sensor related to whether the body part of the user is touching the table, and
control operation of the motor in response to the sensing portion detecting that the body part of the user is in proximity to the table.

2. The power tool of claim 1, wherein the sensor is a capacitive sensor.

3. The power tool of claim 1, wherein the power tool is a tabletop saw.

4. The power tool of claim 3, wherein, to control operation of the motor in response to the sensing portion detecting that the body part of the user is in proximity to the table, the controller is further configured to disable the tabletop saw.

5. The power tool of claim 1, wherein the sensing portion is configured to detect a body part of the user in proximity to the table.

6. The power tool of claim 5, wherein the sensing portion is configured to detect a body part of the user touching a worksurface the table.

7. A power tool comprising:
a housing including a handle, the handle configured to be grasped by a user during operation;
a first touch sensor disposed in the handle;
a motor supported by the housing, the motor configured to drive a tool output;
a second touch sensor disposed adjacent the tool output; and
a controller connected to the first touch sensor, the second touch sensor, and the motor, the controller configured to:
determine that the user is grasping the handle based on a first sensor signal from the first touch sensor,
determine that flesh is not in proximity to the tool output based on a second sensor signal from the second touch sensor, and
permit operation of the motor.

8. The power tool of claim 7, wherein the power tool is a stapler.

9. The power tool of claim 7, wherein the first touch sensor is a capacitive sensor.

10. The power tool of claim 7, wherein, to determine that the user is grasping the handle, the controller is further configured to detect, via the first touch sensor, that flesh is touching the handle.

11. The power tool of claim 7, wherein, to determine that flesh is not in proximity to the tool output, the controller is further configured to detect, via the second touch sensor, that flesh is not touching the second touch sensor.

12. The power tool of claim 7, wherein the controller is further configured to:
determine that flesh is in proximity to the tool output based on a further second sensor signal from the second touch sensor; and
disable operation of the motor.

13. The power tool of claim 12, wherein, to determine that flesh is in proximity to the tool output, the controller is further configured to detect, via the second touch sensor, that flesh is touching the second touch sensor.

14. A power tool comprising:
a housing;
a handle coupled to the housing and configured to be grasped by a user during operation;
a motor supported by the housing;
a sensing portion including a sensor, the sensing portion configured to detect a body part of the user in proximity to the sensing portion; and
a controller connected to the motor and the sensor, the controller configured to:
receive a signal from the sensor related to whether the body part of the user is in proximity to the power tool, and
prohibit operation of the motor in response to detecting that the body part of the user is not in proximity to the sensing portion.

15. The power tool of claim 14, wherein the power tool is a stapler.

16. The power tool of claim 15, wherein, to detect that the body part of the user is in proximity to the sensing portion, the controller is further configured to detect that a user is grasping the handle.

17. The power tool of claim 16, wherein, to detect that the user is not grasping the handle, the controller is further configured to:
detect, via the sensor, that flesh is not touching the sensing portion; and
prohibit operation of the motor in response to detecting that flesh is not touching the sensing portion.

18. The power tool of claim 16, wherein, to detect that a user is grasping the handle, the controller is further configured to:
detect, via the sensor, that flesh is touching the sensing portion; and
permit operation of the motor in response to detecting that flesh is touching the sensing portion.

19. The power tool of claim 14, wherein the power tool is a multi-tool.

20. The power tool of claim 19, wherein the sensing portion includes a plurality of sensors.
